(19) United States
(12) Patent Application Publication
(10) Pub. No.: US 2026/0044307 A1
(43) Pub. Date: Feb. 12, 2026

(54) SYSTEM AND METHOD FOR CONTROLLING A PLURALITY OF AUDIO STREAMS IN AN AUDIO DEVICE

(71) Applicant: Samsung Electronics Co., Ltd., Suwon-si (KR)

(72) Inventors: Ankit AGARWAL, Noida (IN); Desh Deepak AGARWAL, Noida (IN); Priyanshu AGRAWAL, Noida (IN); Vansh NARANG, Noida (IN); Harish Kumar SHARMA, Noida (IN)

(21) Appl. No.: 19/307,862

(22) Filed: Aug. 22, 2025

Related U.S. Application Data
(63) Continuation of application No. PCT/KR2025/008096, filed on Jun. 12, 2025.

(30) Foreign Application Priority Data
Aug. 12, 2024 (IN) 202411060951

(51) Int. Cl. G06F 3/16; G06F 3/04817; H04R 3/12; H04R 5/033; H04R 5/04

(52) U.S. Cl. CPC G06F 3/165; G06F 3/04817; H04R 3/12; H04R 5/033; H04R 5/04

(57) ABSTRACT

A method for controlling at least one of a plurality of audio streams in an audio device is disclosed. The method includes: receiving a first audio stream and a second audio stream from the plurality of audio streams, wherein each of the first audio stream and the second audio stream corresponds to an encoded signal having a watermark, wherein of the first audio stream and the second audio stream is received from a User Equipment (UE); initiating an operation of the first audio stream and the second audio stream on the audio device; and controlling the operation of at least one of the first audio stream and the second audio stream based on receiving an input.

### CROSS-REFERENCE TO RELATED APPLICATIONS

This application is a continuation of International Application No. PCT/KR2025/008096 designating the United States, filed on Jun. 12, 2025, in the Korean Intellectual Property Receiving Office and claiming priority to Indian Patent Application number 202411060951, filed on Aug. 12, 2024, in the Indian Patent Office, the disclosures of each of which are incorporated by reference herein in their entireties.

### BACKGROUND

### Field

The disclosure relates to audio devices, and for example, relates to a method and a system for controlling a plurality of audio streams in an audio device.

### Description of Related Art

In today's fast-paced digital world, audio devices, for example, a pair of headphones, a pair of earbuds, etc., have revolutionized personal audio consumption for a user. The audio devices offer a tailored listening experience that ranges from immersive high-fidelity sound to convenient portability. With advancements in technology, modern audio devices come equipped with features such as noise-cancellation, wireless connectivity, seamlessly integrating sounds from multiple applications running simultaneously on any connected electronic devices, etc., enhancing both comfort and auditory quality.

Generally, an audio device is connected to an electronic device, for example, a smartphone of the user to deliver the audio content to the user. Typically, referring to FIG. 1A, when the audio device 104 is switched ON, then, the audio device 104 becomes in pairing mode. Further, the audio device 104, once in the pairing mode, broadcasts its pairing information, in the form of a signal, which is detected by the smartphone 106. Further, once the signal is selected on the smartphone 106, the smartphone 106 and the audio device 104 get connected with each other. For example, the audio device 104 gets connected with the smartphone 106 through a plurality of connections, for example, a secondary connection 102 and a simultaneous connection 108. Thereafter, the audio device 104 communicates with the smartphone 106 wirelessly through ultra-high frequency (UHF) radio waves, which are electromagnetic waves with a frequency of about 2.4 gigahertz (GHz). Further, the audio device 104 receives a plurality of audio streams from a plurality of applications running on the smartphone 106 and delivers the audio content accordingly to the user. Particularly, referring to FIGS. 1B and 1C, the plurality of applications is running on the smartphone 106, where a plurality of audio streams from each application is mixed by a mixer 110. Further, the mixed plurality of audio streams is transmitted to the audio device 104 by a transceiver 112 of the smartphone 106. When the audio device 104 receives the mixed audio signal, a transceiver 114 of the audio device 104 transmits the plurality of audio streams to each speaker 116, 118 of the audio device 104, thus providing audio content to the user.

However, the current configuration, as discussed above, has certain limitations, that each speaker 116, 118 of the audio device 104 receives mixed audio streams from the smartphone 106 and thus, provides mixed audio content from each speaker 116, 118 to the user. In this scenario, the user can only control the overall mixed audio streams via the audio device 104 as the audio device 104 operates on touch and voice input. Further, this configuration lacks in providing independent control of each audio stream on each speaker respectively. This becomes cumbersome for the user as the user has to always operate the smartphone 106 to control the particular audio stream playing on one speaker of the audio device 104. Thus, this process increases discomfort for the user.

Therefore, in view of the above-mentioned problems, it may be advantageous to provide an improved system and method that can address the above-mentioned problems and limitations associated with controlling of the plurality of audio streams in the audio device.

### SUMMARY

According to an example embodiment of the present disclosure, disclosed herein is a method for controlling at least one of a plurality of audio streams in an audio device. The method includes: receiving a first audio stream and a second audio stream from the plurality of audio streams, wherein each of the first audio stream and the second audio stream represents an encoded signal having a watermark; initiating an operation of the first audio stream and the second audio stream on the audio device; and controlling the operation of at least one of the first audio stream and the second audio stream based on receiving an input (e.g., user input).

According to an example embodiment of the present disclosure, disclosed herein is a method for controlling at least one of a plurality of audio streams. The method includes: receiving, by a user equipment (UE), a first audio stream and a second audio stream from the plurality of audio streams intended to be streamed on an audio device; encoding, by the UE, the first audio stream and the second audio stream, and a watermark corresponding to each of the first audio stream and the second audio stream to generate a mixed encoded signal; and transmitting, by the UE, each of a first watermarked audio stream and a second watermarked audio stream, from the generated mixed encoded signal, to the audio device such that an operation of at least one of the first watermarked audio stream and the second watermarked audio stream are controlled based on receiving an input on the audio device.

The present disclosure discloses a system for controlling at least one of a plurality of audio streams in an audio device. The system includes: a memory and at least one processor, comprising processing circuitry, where at least one processor is communicatively coupled with the memory, wherein at least one processor, individually and/or collectively, is configured to cause the system to: receive a first audio stream and a second audio stream from the plurality of audio streams, wherein of the first audio stream and the second audio stream represents an encoded signal having a watermark; initiate an operation of the first audio stream and the second audio stream on the audio device; and control the operation of at least one of the first audio stream and the second audio stream based on receiving an input.

To further clarify the advantages and features of the present disclosure, a more particular description will be rendered with reference to various example embodiments thereof, which are illustrated in the appended drawings. It is appreciated that these drawings depict example embodiments of the disclosure and are therefore not to be considered limiting its scope. The disclosure will be described and explained with additional specificity and detail with the accompanying drawings.

### BRIEF DESCRIPTION OF THE DRAWINGS

The foregoing and other aspects, features and advantages of certain embodiments of the present disclosure will be more apparent from the following detailed description, taken in conjunction with the accompanying drawings, in which like reference numerals refer to like elements and in which:

FIGS. 1A, 1B and 1C are diagrams illustrating controlling of at least one of a plurality of audio streams, according to the prior-art;

FIG. 2 is a diagram illustrating an example environment having a system for controlling at least one of a plurality of audio streams in an audio device, according to various embodiments;

FIG. 3 is a block diagram illustrating an example configuration of the system for controlling at least one of the plurality of audio streams in the audio device, according to various embodiments;

FIG. 4 is a diagram illustrating an example operation of the system, according to various embodiments;

FIGS. 5A and 5B are diagrams illustrating illustrate example watermarking of a first audio stream and a second audio stream on a UE, according to various embodiments;

FIG. 6 is a diagram illustrating example generation of a mixed encoded signal on the UE, according to various embodiments;

FIG. 7 is a diagram illustrating example conversion of the mixed encoded signal into a stereo signal, according to various embodiments;

FIG. 8 is a diagram illustrating an example operation of the audio intelligence engine on the UE, according to various embodiments;

FIG. 9 is a diagram illustrating example decoding of the signals at the audio device, according to various embodiments;

FIG. 10A is a diagram illustrating example transmitting of a control signal from the audio device to the UE, according to various embodiments;

FIG. 10B is a diagram illustrating example receiving of the control signal by the UE from the audio device, according to various embodiments;

FIG. 11 is a flowchart illustrating an example method performed by the system for controlling the at least one of the plurality of audio streams in the audio device, according to various embodiments;

FIG. 12 is a flowchart illustrating an example method performed by the UE for controlling the at least one of the plurality of audio streams in the audio device, according to various embodiments; and

FIGS. 13A and 13B are diagrams illustrating an example use case of the system, according to various embodiments.

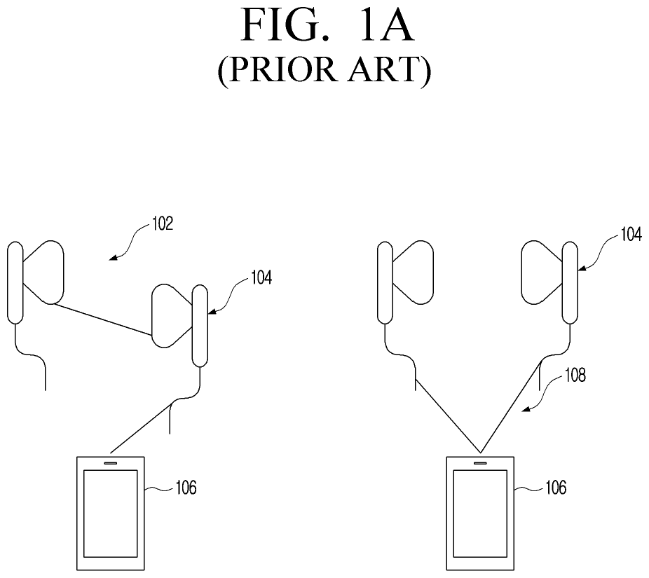

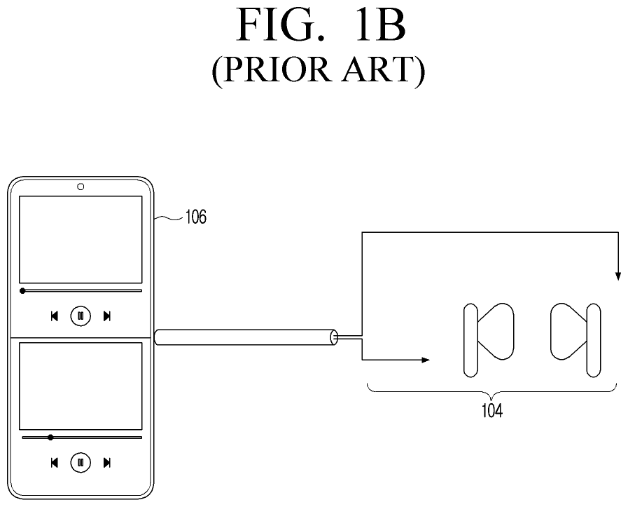

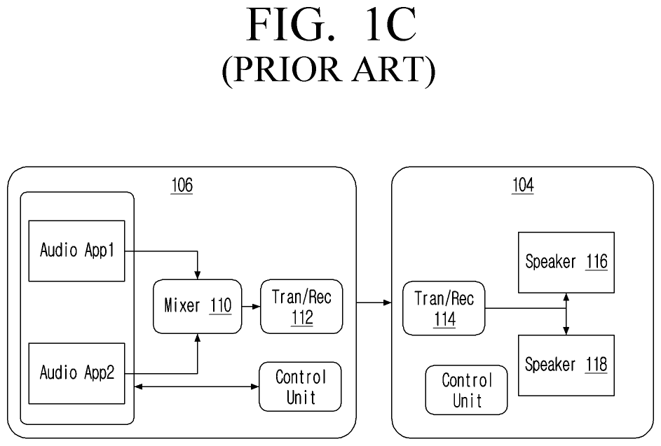

### DETAILED DESCRIPTION

For the purpose of promoting an understanding of the principles of the present disclosure, reference will now be made to the various example embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to various “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The system and method as disclosed enable a user to control multiple audio streams independently in an audio device. The method receives a first audio stream and a second audio stream from a user equipment. This is followed by adding control information (watermark) in the first audio stream and the second audio stream and encoding watermarked audio signals into a mixed audio signal. The control information/watermark is encoded using a bit-stream watermark technique. An input (e.g., a user input) may be received via an interface of a first channel or second channel of the audio device for controlling a function of the first audio stream and the second audio stream independently. The control function includes a volume adjustment and play/pause control. The controlling is performed based on the corresponding control information within the mixed audio signal. The control information is adapted to configure the first channel and second channel to control the first audio stream and the second audio stream respectively.

Various example embodiments of the present disclosure will be described in greater detail below with reference to the accompanying drawings.

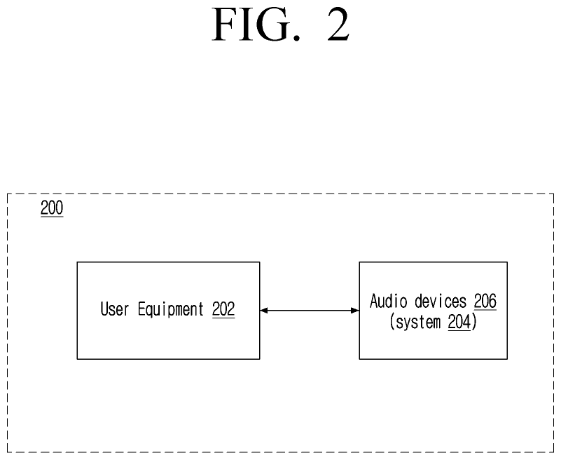

FIG. 2 is a diagram illustrating an example environment 200 depicting a system 204 for controlling at least one of a plurality of audio streams, according to various embodiments. In an embodiment, the system 204 may be deployed in the audio device 206, without departing from the scope of the present disclosure. In an embodiment, the system 204 may be in communication with an audio device 206, without departing from the scope of the present disclosure. In an embodiment, the audio device 206 may be in connection with a user equipment (UE) 202, without departing from the scope of the present disclosure. In an embodiment, the UE 202 may be a smartphone, without departing from the scope of the present disclosure. In an embodiment, the user equipment 202 may be any electronic device compatible to play the plurality of audio streams, without departing from the scope of the present disclosure. Further, in an embodiment, audio device 206 may be at least one of a pair of earbuds, a pair of headphones, etc., which may be in connection with the user equipment 202, without departing from the scope of the present disclosure.

In an embodiment, the UE 202 may be configured to transmit a first audio stream and a second audio stream from the plurality of audio streams, from one or more applications installed on the UE 202, to the audio device 206. Further, in an embodiment, the audio device 206 may be configured to receive the first audio stream and the second audio stream such that the system 204 deployed in the audio device 206 may control operation of the at least one of the first audio stream and the second audio stream, independently, based on receiving a user input on the audio device 206. This process ensures control of the first audio stream and the second audio stream, independently, on the audio device 206, thus ensuring the comfort of a user.

Further, the system 204 is described in greater detail below with reference to various diagrams.

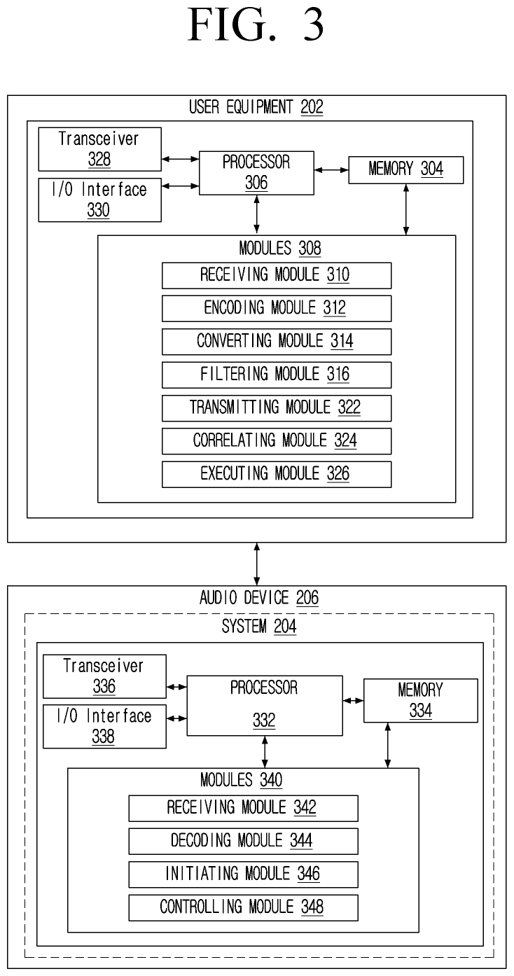

FIG. 3 is a block diagram illustrating an example configuration of the system 204 for controlling at least one of the plurality of audio streams, according to various embodiments.

In an embodiment, the system 204 may include, but is not limited to, an audio device 206. The audio device 206 may include at least one processor (referred to here as one or more processor, a processor including various processing circuitry) 332, a memory 334, and a plurality of modules (e.g., each including various circuitry and/or executable program instructions) 340 among other examples which are explained in detail below.

The audio device 206 of the system 204 may include a transceiver 336 and an Input/Output (I/O) interface (e.g., including circuitry) 338. In various embodiments where the system 204 is implemented as a standalone entity at a server/cloud architecture, the system 204 may be in communication with multiple devices to receive data from each device.

In an example embodiment, the processor 332 may be communicatively coupled with the memory 334. The processor 332 may be operatively coupled to each of the I/O interface 338, the plurality of modules 340, and the transceiver 336. In an embodiment, the processor 332 may include an artificial intelligence (AI) engine (AIE). In an embodiment, the processor 332 may include at least one data processor for executing processes in a virtual storage area network. The processor 332 may include specialized processing units such as, integrated system (bus) controllers, memory management control units, floating point units, graphics processing units, digital signal processing units, etc. In an embodiment, the processor 332 may include a central processing unit (CPU). The processor 332 may be one or more general processors, digital signal processors, application-specific integrated circuits, field-programmable gate arrays, servers, networks, digital circuits, analog circuits, combinations thereof, or other now-known or later developed devices for analyzing and processing data. The processor 332 may execute a software program, such as code generated manually (e.g., programmed) to perform the desired operation. Thus, the processor 332 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 332 may be disposed in communication with one or more input/output (I/O) devices via the I/O interface 338. In various embodiments, the processor 332 may communicate with the audio device 206 using the I/O interface 338. In various embodiments, the I/O interface 338 may be implemented within the audio device 206.

Using the I/O interface 338, the system 204 may communicate with one or more I/O devices, for example, the audio device 206, where the system 204 controls the operation of at least one of the first audio stream and the second audio stream independently on the audio device 206. For example, the input device may be an antenna, microphone, touch screen, touchpad, storage device, transceiver, recording device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 332 may be disposed in communication with a communication network via a network interface. In an embodiment, the network interface may be the I/O interface 338. The network interface may connect to the communication network to enable the connection of the system 204 with the audio device 206. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 204 may communicate with other devices. Further, the audio device 206 having the system 204 may establish communication with the UE 202 with at least one communication channel, for example, wireless technology, wired technology. In an embodiment, the wireless technology may include, but is not limited to, a Bluetooth connection.

The transceiver 336 may be configured to receive and/or transmit signals to and from the audio device 206. In an embodiment, the database may be configured to store the information as required by the plurality of modules 340 and the processor 332 for controlling at least one of the first audio stream and the second audio stream on the audio device 206, independently.

In various embodiments, the memory 334 may be communicatively coupled to the processor 332. The memory 334 may be configured to store data, and instructions executable by the processor 332. In an embodiment, the memory 334 may be provided within the audio device 206. In an embodiment, the memory 334 may be provided within the system 204 being remote from the audio device 206. In an embodiment, the memory 334 may communicate with the processor 332 via a bus within the system 204. In an embodiment, the memory 334 may be located remotely from the processor 332 and may be in communication with the processor 332 via a network. The memory 334 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In an example, the memory 334 may include a cache or random-access memory for the processor 332. In various examples, the memory 334 is separate from the processor 332, such as a cache memory of a processor, the system memory, or other memory. The memory 334 may be an external storage device or database for storing data. The memory 334 may be operable to store instructions executable by the processor 332. The functions, acts, or tasks illustrated in the figures or described may be performed by the programmed processor 332 for executing the instructions stored in the memory 334. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

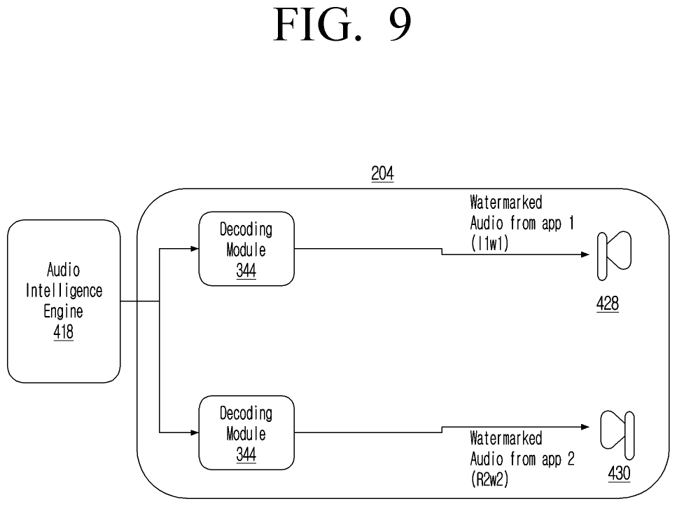

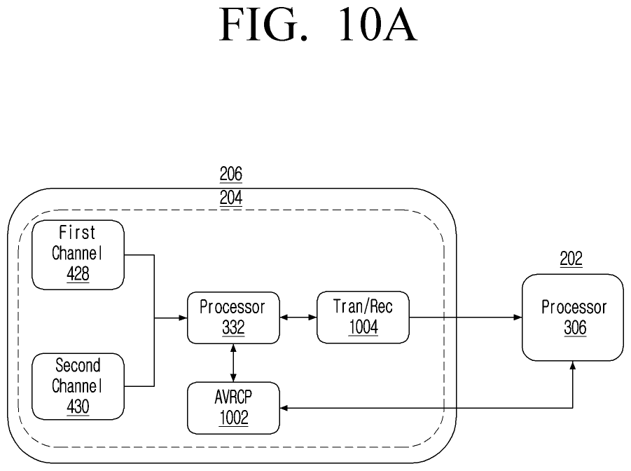

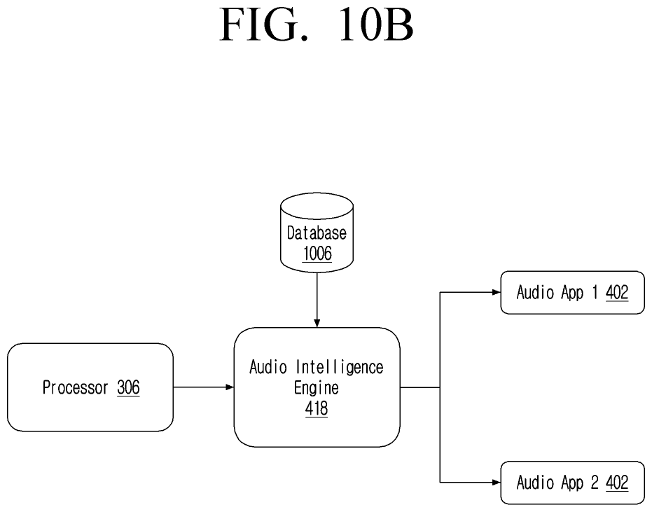

In various embodiments, the plurality of modules 340 may be included within the memory 334. The memory 334 may further include a database to store data. The plurality of modules 340 may include a set of instructions that may be executed to cause the system 204, in particular, the processor 332 of the system 204, to perform any one or more of the methods/processes disclosed herein. The plurality of modules 340 may be configured to perform the steps of the present disclosure using the data stored in the database. For instance, the plurality of modules 340 may be configured to perform the steps disclosed in FIGS. 9-10A.

In an embodiment, each of the plurality of modules 340 may be a hardware unit which may be outside the memory 334. Further, the memory 334 may include an operating system for performing one or more tasks of the system 204, as performed by a generic operating system.

In an example, the modules 340 may include a receiving module 342, a decoding module 344, an initiating module 346, and a controlling module 348. Each of the modules 342-346 are in communication with each other. Further, each of the modules 342-346 may be in communication with the processor 332.

Further, the disclosure also contemplates a computer-program product that includes instructions or receives and executes instructions responsive to a propagated signal. Further, the instructions are transmitted or received over the network via a communication port or interface or using a bus (not shown). The communication port or interface may be a part of the processor 332 or may be a separate component. The communication port may be created in software or may be a physical connection in hardware. The communication port may be configured to connect with the network, external media, the display, or any other components in the system 204. The connection with the network may be a physical connection, such as a wired ethernet connection, or may be established wirelessly. Likewise, the additional connections with other components of the system 204 may be physical or may be established wirelessly. The network may alternatively be directly connected to the bus.

In an embodiment, the computer-program product, having machine-readable instructions stored therein, when executed by the processor 332, causes the processor 332 to perform an operation for controlling the operation of at least one of the first audio stream and the second audio stream on the audio device 206, independently. The operation(s) performed by the processor 332 are described in greater detail below at least with reference to FIGS. 9 and 10A.

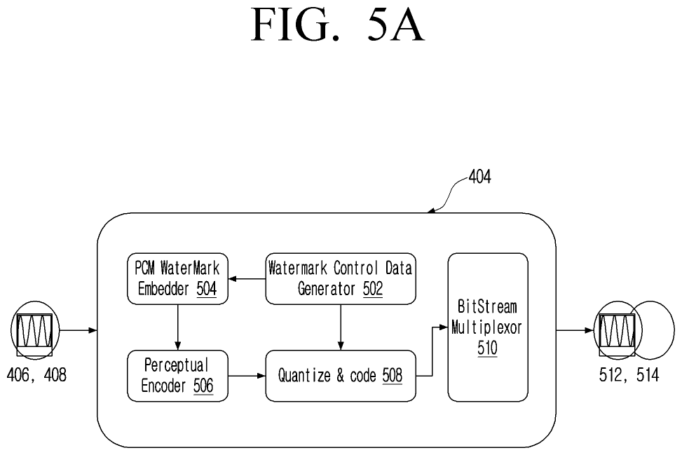

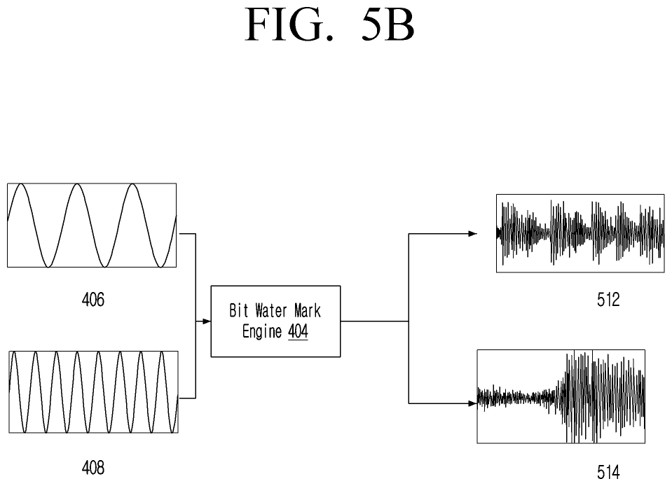

Further, in an embodiment, the UE 202 may include, but is not limited to, at least one processor (referred to here as one or more processor, a processor including processing circuitry) 306, a memory 304, a transceiver 328, an I/O interface (e.g., including circuitry) 330, and a plurality of modules (e.g., each including various circuitry and/or executable program instructions) 308. The configuration of the at least one processor (referred to here as one or more processor, a processor) 306, the memory 304, the transceiver 328, the I/O interface 330 may be similar to that of the system 204. Accordingly, a detailed description of the same may not be repeated here for the sake of brevity of the present disclosure. Further, the module 308 may include a receiving module 310, an encoding module 312, a converting module 314, a filtering module 316, a transmitting module 322, a correlating module 324, and an executing module 326. The operation(s) performed by the processor 306 along with each module 310-326 are described in greater detail below at least with reference to FIGS. 5A, 5B, 6, 7 and 8 and FIG. 10B.

The processor 332, in conjunction with the modules 342-346, along with the processor 306, in conjunction with the modules 310-326 may be configured to perform specific operations in the subsequent paragraphs. The subsequent paragraphs explain the operations of the processor 306, the modules 310-326 in conjunction with the processor 332, the modules 342-346, to control at least the first audio stream and the second audio stream, independently, in the audio device 206.

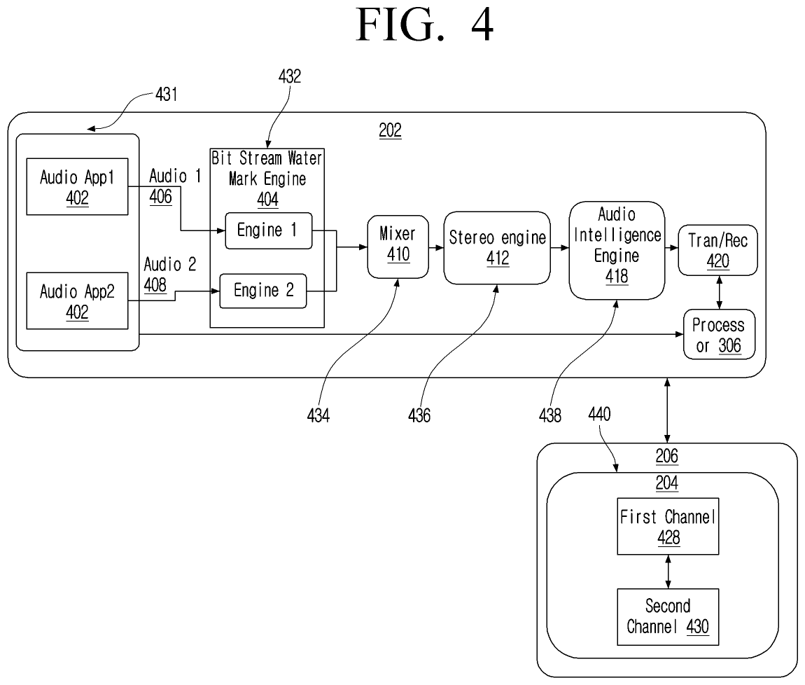

FIG. 4 is a diagram illustrating an example operation performed by the system 204 along with the UE 202, according to various embodiments. In an embodiment at block 431, the first audio stream 406 and the second audio stream 408 from the plurality of audio streams may be received from one or more applications 402 installed on the UE 202. At block 432, each of the first audio stream 406 and the second audio stream 408 may be encoded by a bit-stream watermark engine 404 provided on the UE 202. At block 434, after encoding, each of the first audio stream 406 and the second audio stream 408 may be mixed in a mixer 410 provided on the UE 202 to generate a mixed encoded signal. At block 436, the generated mixed audio signal may be converted to a stereo signal by a stereo engine 412 of the UE 202. Further, at block 438, the stereo signal may be provided to an audio intelligence engine 418, where operation, for example, filtering, may be performed to decide that at least one of the first audio stream 406 and the second audio stream 408 may be decoded on each on a first channel 428 and a second channel 430 of the audio device 206. In an embodiment, the first channel 428 indicates a first speaker of the audio device 206, without departing from the scope of the present disclosure. Further, the second channel 430 indicates a second speaker of the audio device 206, without departing from the scope of the present disclosure. Furthermore, in an embodiment, each audio stream may be decoded and streamed on each speaker of the audio device 206. The first audio stream 406 and the second audio stream 408 may be transmitted to the audio device 206 through a transceiver 420, where the system 204 receives the first audio stream 406 and the second audio stream 408. At block 440, the system 204 may control the operation of the at least one of the first audio stream 406 and the second audio stream 408 on the audio device 206, independently, based on the receiving of the user input. Lastly, based on the operation, the system 204 may communicate to the UE 202 to either start/stop/perform any other operation on the at least one of the first audio stream 406 and the second audio stream 408 independently.

The operations mentioned above are explained in greater detail below with reference to FIGS. 5A, 5B, 6, 7, 8, 9, 10A and 10B (which may be referred to as FIGS. 5A to 10B).

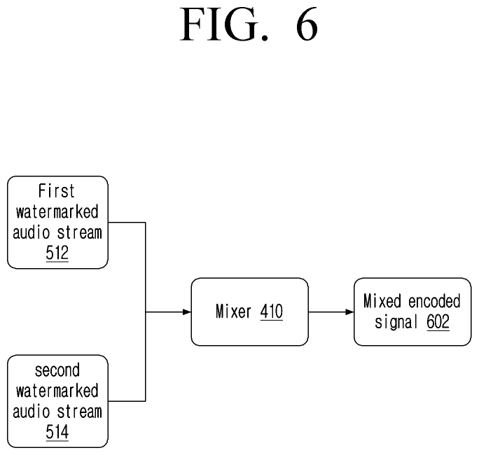

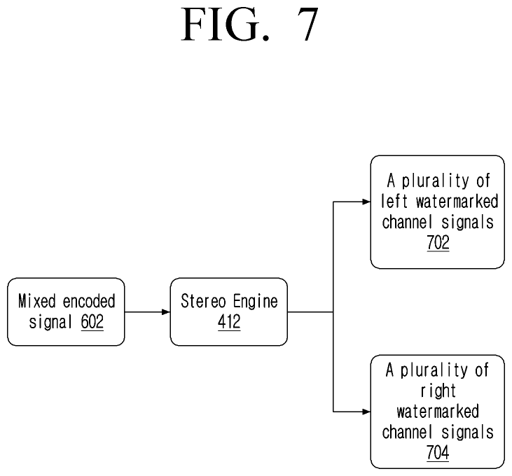

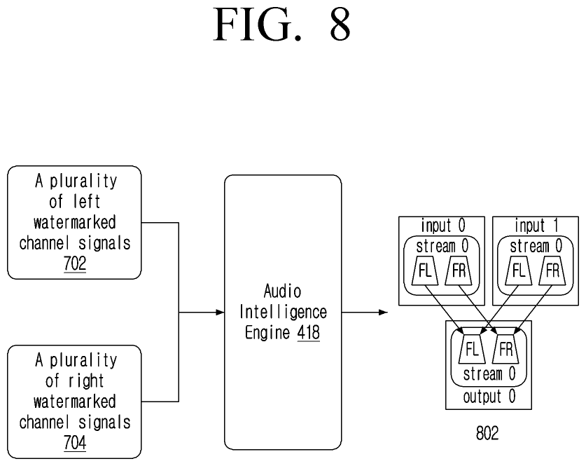

FIGS. 5A and 5B are diagrams illustrating example watermarking of the first audio stream 406 and the second audio stream 408 on the UE 202, according to various embodiments. FIG. 6 is a diagram illustrating example generation of a mixed encoded signal on the UE 202, according to various embodiments. FIG. 7 is a diagram illustrating example conversion of the mixed encoded signal 602 into the stereo signal, according to various embodiments. FIG. 8 is a diagram illustrating an example operation of the audio intelligence engine 418, according to various embodiments. FIG. 9 is a diagram illustrating example decoding of the signals at the audio device 206, according to various embodiments. FIG. 10A is a diagram illustrating example transmitting of a control signal from the audio device 206 to the UE 202, according to various embodiments. FIG. 10B is a diagram illustrating example receiving of the control signal by the UE 202 from the audio device 206, according to various embodiments.

In the present disclosure, FIGS. 5A to 10B along with FIG. 4 are explained in conjunction for the sake of brevity.

In an embodiment, referring to block 431, the receiving module 310 may be configured to receive the first audio stream 406 and the second audio stream 408 from the plurality of audio streams intended to be streamed on the audio device 206. The first audio stream 406 and the second audio stream 408 may be received from the one or more applications 402 installed on the UE 202. In an embodiment, the first audio stream 406 and the second audio stream 408 may be received from the one or more applications 402 as used by the user on the UE 202. In one example, the first audio stream 406 is a song received from a music related application installed on the UE 202 and the second audio stream 408 is a podcast from another application installed on the UE 202.

Referring to block 432 and FIGS. 5A and 5B, the encoding module 312 may be configured to encode the first audio stream 406 and the second audio stream 408 and a watermark corresponding to each of the first audio stream 406 and the second audio stream 408 to generate the mixed encoded signal 602. The watermark may include an audio control information to configure the audio device 206 to control each of the first audio stream 406 and the second audio stream 408 independently of each other. The watermark corresponding to each of the first audio stream 406 and the second audio stream 408 may be generated using a bit-stream watermark modulation technique performed by the bit-stream watermark engine 404. The first audio stream 406 and the second audio stream 408, and the watermark corresponding to each of the first audio stream 406 and the second audio stream 408 are encoded using a pulse code modulation technique.

In an embodiment, the bit-stream watermark engine 404 may include a watermark control data generator 502, a pulse code modulation (PCM) watermark embedder 504, a perceptual encoder 506, a quantize and code engine 508, and a bit-stream multiplexor 510. The watermark control data generator 502 may generate audio control information that is to be watermarked in each of the first audio stream 406 and the second audio stream 408. Further, the pulse code modulation (PCM) watermark embedder 504 may be configured to convert each of the first audio stream 406 and the second audio stream 408 from an analog signal to a PCM signal. For example, the number of frames in the analog signal may be computed by Fast Fourier transformation (FFT) using FFT ( ) API as shown in FIG. 5A. DEc2bin may convert decimal integers to binary numbers. The output argument may be a character vector representing 0,1, thus representing the PCM signal. The perceptual encoder 506 may be configured to encode the generated audio control information with each of the PCM signals to watermark each PCM signal by the pulse code modulation technique. Further, the quantize and code engine 508 of the bit-stream watermark engine 404 may be configured to quantize the watermarked PCM signal and thereafter, decode the quantized watermarked PCM signal.

The bit-stream multiplexor 510 of the bit-stream watermark engine 404 may be configured to multiplex the decoded watermarked PCM signal to generate the first watermarked audio stream 512 and the second watermarked audio stream 514 in an analog audio signal format, by the bit-stream watermark modulation technique. Particularly, Pix is a dynamic array containing a numeric vector that converts decimal integers into binary representation and in minimum length of 8. The output waveform, e.g., the first watermarked audio stream 512 and the second watermarked audio stream 514 may be generated using the Inverse Fast Fourier transform (ifft) ( ) technique. Thus, this process provides the first watermarked audio stream 512 and the second watermarked audio stream 514 in the analog audio signal format.

Referring to block 434 and FIG. 6, each of the first watermarked audio stream 512 and the second watermarked audio stream 514 may be mixed by the mixer 410 to generate the mixed encoded signal 602. In an embodiment, stem ( ) may be used for quantization of each of the first watermarked audio stream 512 and the second watermarked audio stream 514. Each of the first watermarked audio stream 512 and the second watermarked audio stream 514 are encoded into a digital PCM signal. The mixer 410 may be configured to mix each of the digital PCM signals corresponding to each of the first watermarked audio stream 512 and the second watermarked audio stream 514 to generate the mixed encoded signal 602 in the PCM signal format. Particularly, Reshape ( ) may be used for decoding the quantized digital PCM signal frame by frame and converting the frame of 1 byte for generating the mixed encoded signal 602. In an embodiment, the mixed encoded signal 602 may also have the watermark, without departing from the scope of the present disclosure.

In an embodiment, referring to block 436 and FIG. 7, the converting module 314 may be configured to convert the generated mixed encoded signal 602 into the stereo signals with the help of the stereo engine 412. The stereo signal may include a plurality of left watermarked channel signals 702 and a plurality of right watermarked channel signals 704. The plurality of left watermarked channel signals 702 corresponds to each of the first audio stream 406 and the second audio stream 408. The plurality of right watermarked channel signals 704 corresponds to each of the first audio stream 406 and the second audio stream 408. Each of the plurality of left watermarked channel signals 702 and the plurality of right watermarked channel signals 704 may be in a PCM signal format, without departing from the scope of the present disclosure.

In an embodiment, the converting module 314 along with the stereo engine 412 may be configured to normalize the generated mixed encoded signal 602 with a predetermined technique, for example, hyperbolic tangent activation function. The generated mixed encoded signal 602 may be separated into multiple watermarked channel signals corresponding to each of the first audio stream 406 and the second audio stream 408 by one or more predetermined techniques, for example, a Fastica technique. The converting module 314 along with the stereo engine 412 may be configured to merge a set of watermarked channel signals from the multiple watermarked channel signals to form the plurality of left watermarked channel signals 702. Further, the converting module 314 along with the stereo engine 412 may be configured to merge another set of watermarked channel signals from the multiple watermarked channel signals to form the plurality of right watermarked channel signals 704. In an embodiment, the set of watermarked channel signals may include a portion of each of the first audio stream 406 and the second audio stream 408. Further, another set of watermarked channel signals includes another portion each of the first audio stream 406 and the second audio stream 408. In an example, the first audio stream 406 includes L1W1 signal and R1W1 signal as a portion. Further, the second audio stream 408 may include L2W2 signal and R2W2 signal as a portion. Further, the L1W1 signal and L2W2 signal are merged to form the plurality of left watermarked channel signals 702. Further, the R1W1 signal and R2W2 signal are merged to form the plurality of right watermarked channel signals 704.

After conversion of the generated mixed encoded signal 602 to the stereo signal, in an embodiment, referring to FIG. 8 and block 438, the filtering module 316 along with the audio intelligence engine 418 may be configured to filter each of the plurality of left watermarked channel signals 702 and the right watermarked channel signals 704. The filtering module 316 along with the audio intelligence engine 418 may filter each watermarked channel signal to decide that at least one filtered left watermarked channel signal and at least one filtered right watermarked channel signal, as shown by 802, is to be decoded on the first channel 428 and the second channel 430 of the audio device 206, respectively. In an embodiment, the filtering module 316 along with the audio intelligence engine 418 may filter each watermarked channel signal to decide that at least one filtered left watermarked channel signal and at least one filtered right watermarked channel signal, as shown by 802, is to be decoded on the second channel 430 and the first channel 428 of the audio device 206, respectively.

In an embodiment, the filtering module 316 along with the audio intelligence engine 418 may determine a value corresponding to each of the plurality of left watermarked channel signals and the plurality of right watermarked channel signals, based on a received characteristics of each channel of the audio device 206. Further, the filtering module 316 along with the audio intelligence engine 418 may prioritize the at least one left watermarked channel signal having a higher determined value with respect to the determined values of other left watermarked channel signals. Simultaneously, the filtering module 316 along with the audio intelligence engine 418 may prioritize the at least one right watermarked channel signal having a higher determined value with respect to the determined values of other right watermarked channel signals. The prioritization assists in deciding that the at least one filtered left watermarked channel signal and the at least one filtered right watermarked channel signal, as shown by 802, are to be decoded on the first channel 428 and the second channel 430, respectively. In an embodiment, the prioritization assists in deciding that the at least one filtered left watermarked channel signal and the at least one filtered right watermarked channel signal, as shown by 802, is to be decoded on the second channel 430 and the first channel 428, respectively, without departing from the scope of the present disclosure.

After deciding that the at least one filtered left watermarked channel signal and the at least one filtered right watermarked channel signal, as shown by 802, are to be decoded, the transmitting module 322 may be configured to transmit each of a first watermarked audio stream and a second watermarked audio stream, from the generated mixed encoded signal 602, to the audio device 206. The transmitting module 322 may transmit such that an operation of at least one of the first watermarked audio streams and the second watermarked audio stream are controlled based on receiving a user input on the audio device 206.

In an embodiment, the transmitting module 322 may be configured to transmit each of the filtered plurality of left watermarked channel signals and the filtered plurality of right watermarked channel signals to the audio device 206. The transmitting module 322 may transmit each signal such that the audio device 206 decodes each of the at least one filtered left watermarked channel signal on the first channel 428 and the at least one filtered right watermarked channel signal on the second channel 430. In an embodiment, the transmitting module 322 may transmit each signal such that the audio device 206 decodes each of the at least one filtered left watermarked channel signal on the second channel 430 and the at least one filtered right watermarked channel signal on the first channel 428, without departing from the scope of the present disclosure. Further, the audio device 206 controls the operation of at least one of the at least one filtered left watermarked channel signal and the at least one filtered right watermarked channel signal based on receiving the user input on the audio device 206.

In an embodiment, referring to FIG. 9 and block 440, the system 204 deployed in the audio device 206 may be configured to receive the signals from the transmitting module 322, without departing from the scope of the present disclosure. In an embodiment, the receiving module 342 may be configured to receive the first audio stream 406 and the second audio stream 408 from the plurality of audio streams. For example, the receiving module 342 may be configured to receive the first audio stream 406 and the second audio stream 408 from the UE 202. Each of the first audio stream 406 and the second audio stream 408 represents an encoded signal having the watermark. In an embodiment, the watermark may include the audio control information for controlling the operation of at least one of the first audio stream 406 and the second audio stream 408 on the audio device 206. Particularly, the receiving module 342 may be configured to receive each of the filtered plurality of left watermarked channel signals and the filtered plurality of right watermarked channel signals corresponding to the first audio stream 406 and the second audio stream 408.

In an embodiment, the decoding module 344 may be configured to decode each of the first audio stream 406 and the second audio stream 408. In such an embodiment, the decoding module 344 may be configured to decode each of the filtered plurality of left watermarked channel signals and the filtered plurality of right watermarked channel signals. The decoding module 344 decodes such that the at least one filtered left watermarked channel signal is decoded on the first channel 428 and the at least one filtered right watermarked channel signal is decoded on the second channel 430. In an embodiment, the decoding module 344 decodes such that the at least one filtered left watermarked channel signal is decoded on the second channel 430 and the at least one filtered right watermarked channel signal is decoded on the first channel 428.

For example, for decoding, the decoding module 344, initially, may be configured to quantize each of the filtered plurality of left watermarked channel signals and the filtered plurality of right watermarked channel signals based on an inverse sampling technique. The decoding module 344 may be configured to sample each of the filtered plurality of left watermarked channel signals and the filtered plurality of right watermarked channel signals based on a uniform sampling technique. The decoding module 344 may be configured to decode the sampled quantized each of the filtered plurality of left watermarked channel signals and the filtered plurality of right watermarked channel signals by the inverse quantization technique. Further, each of the decoded filtered plurality of left watermarked channel signals and the filtered plurality of right watermarked channel signals indicates an analog audio signal.

In an embodiment, after decoding, an initiating module 346 may be configured to initiate the operation of the first audio stream 406 and the second audio stream 408 on the audio device 206. In an embodiment, after decoding, the initiating module 346 may be configured to initiate the operation of the at least one filtered left watermarked channel signal from the decoded filtered plurality of left watermarked channel signals and the at least one filtered right watermarked channel signal from the decoded filtered plurality of right watermarked channel signals on the audio device 206. The operation may include at least one of a play control, a pause control, or a volume control, without departing from the scope of the present disclosure.

In an embodiment, the controlling module 348 may be configured to control the operation of at least one of the first audio stream 406 and the second audio stream 408 based on the receiving user input. In an embodiment, the user input may be at least one of a touch input or a voice input, without departing from the scope of the present disclosure. The operation of each of the first audio stream 406 and the second audio stream 408 may be controlled based on the watermark in accordance with Audio Video Remote Control Profile (AVRCP) 1002. Further, each of the first audio stream 406 and the second audio stream 408 may be configured to be controlled independently of each other. In an embodiment, the controlling module 348 may be configured to control at least one of the at least one filtered left watermarked channel signals on the first channel 428 and the at least one filtered right watermarked channel signal on the second channel 430 based on the receiving user input. In an embodiment, the controlling module 348 may be configured to control at least one of the at least one filtered left watermarked channel signal on the second channel 430 and the at least one filtered right watermarked channel signal on the first channel 428 based on the receiving user input.

In an embodiment, referring to FIG. 10A, when the user input is received to control at least one of the at least one filtered left watermarked channel signal and the at least one filtered right watermarked channel signal, then, based on the user input, the processor 332 accordingly transmit a control signal to the AVRCP 1002. The AVRCP 1002 is a Bluetooth profile configured to remotely control streaming audios, where the control includes at least one of the pause, stop, start playback, volume control, and another type of remote control operations.

Simultaneously, the processor 332 transmits the control signal to the UE 202 through a transceiver 1004 and the AVRC profile 1002 of the system 204. Referring to FIG. 10B, the receiving module 310 may be configured to receive an input, e.g., the control signal, associated with the operation of at least one of the at least one filtered left channel signal and the at least one filtered right channel signal. Further, the correlating module 324 along with the audio intelligence engine 418 may be configured to correlate the received input with a predetermined (e.g., specified) input signal associated with the operation of at least one of the at least one filtered left watermarked channel signal and the at least one filtered right watermarked channel signal. The predetermined input signal may be stored in a database 1006 of the UE 202. The audio intelligence engine 418 may be configured to determine operation/application based on the correlation. Lastly, the executing module 326 may be configured to execute the operation/application, as determined, based on the correlation on the one or more applications 402.

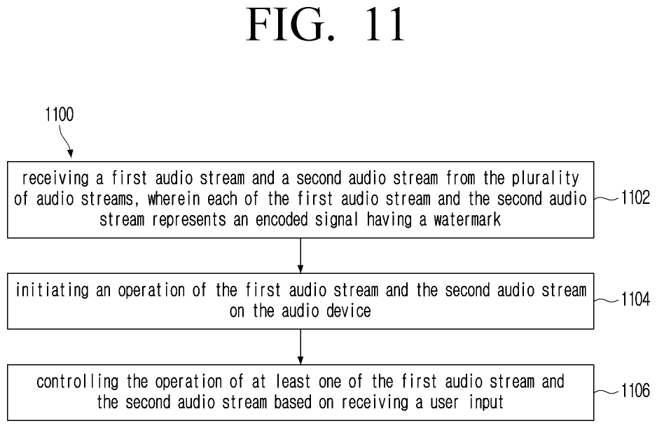

FIG. 11 is a flowchart illustrating an example method 1100 performed by the system 204 for controlling the at least one of the plurality of audio streams in the audio device 206, according to various embodiments.

The method 1100 can be performed by programmed computing devices, for example, based on instructions retrieved from non-transitory computer-readable media. The computer-readable media can include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1100 includes a series of operations shown at 1102 through 1106 of FIG. 11. The method 1100 may be performed by the system 204 in conjunction with the modules 340, the details of which are explained in conjunction with FIGS. 9 and 10A, and the same may not be repeated here for the sake of brevity in the present disclosure.

At 1102, the method 1100 includes receiving the first audio stream 406 and the second audio stream 408 from the plurality of audio streams. Each of the first audio stream 406 and the second audio stream 408 represents the encoded signal having the watermark. The first audio stream 406 and the second audio stream 408 may be received from the UE 202. Further, the watermark includes the audio control information for controlling the operation of at least one of the first audio stream 406 and the second audio stream 408 on the audio device 206.

At 1104, the method 1100 includes initiating the operation of the first audio stream 406 and the second audio stream 408 on the audio device 206. The operation may include at least one of the play control, the pause control, or the volume control. The audio device 206 may include at least one of the pair of earbuds, and the pair of headphones.

At 1106, the method 1100 includes controlling the operation of the at least one of the first audio stream 406 and the second audio stream 408 based on receiving the user input. The operation of each of the first audio stream 406 and the second audio stream 408 is controlled based on the watermark in accordance with the Audio Video Remote Control Profile (AVRCP). Further, each of the first audio stream 406 and the second audio stream 408 may be controlled independently of each other.

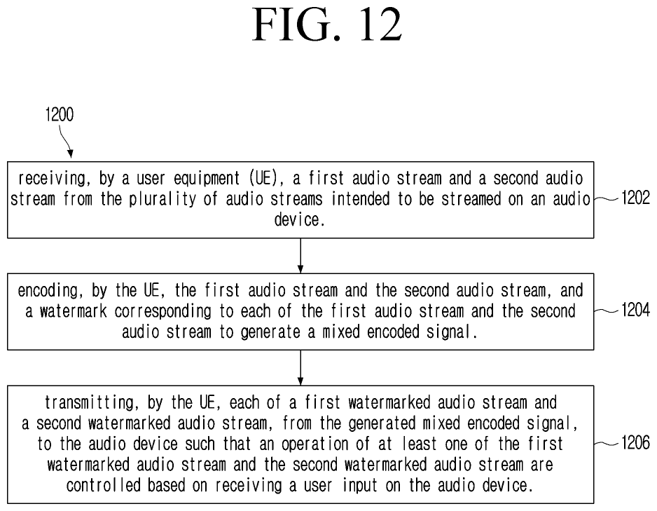

FIG. 12 is a flowchart illustrating an example method 1200 performed by the UE 202 for controlling the at least one of the plurality of audio streams on the audio device 206, according to various embodiments.

The method 1200 can be performed by programmed computing devices, for example, based on instructions retrieved from non-transitory computer-readable media. The computer-readable media can include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1200 includes a series of operations shown at 1202 through 1206 of FIG. 12. The method 1200 may be performed by the processor 306 in conjunction with the modules 308, the details of which are explained in conjunction with FIGS. 5A, 5B, 6, 7 and 8 and 10B, and the same may not be repeated here for the sake of brevity in the present disclosure.

At 1202, the method 1200 includes receiving, by the user equipment (UE) 202, the first audio stream 406 and the second audio stream 408 from the plurality of audio streams intended to be streamed on the audio device 206. The first audio stream 406 and the second audio stream 408 may be received from the one or more applications installed on the UE 202.

At 1204, the method 1200 includes encoding, by the UE 202, the first audio stream 406 and the second audio stream 408, and the watermark corresponding to each of the first audio stream 406 and the second audio stream 408 to generate the mixed encoded signal 602. The watermark includes the audio control information to configure the audio device 206 to control each of the first audio stream 406 and the second audio stream 408 independently of each other. The watermark corresponding to each of the first audio stream 406 and the second audio stream 408 may be generated using the bit-stream watermark modulation technique. The first audio stream 406 and the second audio stream 408 and the watermark corresponding to each of the first audio stream 406 and the second audio stream 406 are encoded using the pulse code modulation technique.

After encoding the first audio stream 406 and the second audio stream 408 and the watermark corresponding to each of the first audio stream 406 and the second audio stream 408, the method 1200 includes converting, by the UE 202, the generated mixed encoded signal 602 into stereo signals. The stereo signals include the plurality of left watermarked channel signals 702 corresponding to each of the first audio stream 406 and the second audio stream 408 and a plurality of right watermarked channel signals 704 corresponding to each of the first audio stream 406 and the second audio stream 408.

The method 1200 includes filtering, by the UE 202, each of the plurality of left watermarked channel signals 702 and the plurality of right watermarked channel signals 704 for deciding that at least one filtered left watermarked channel signal and at least one filtered right watermarked channel signal is to be decoded on the first channel 428 and the second channel 430 of the audio device 206, respectively.

At 1206, the method 1200 includes transmitting, by the UE 202, each of the first watermarked audio stream and the second watermarked audio stream, from the generated mixed encoded signal 602, to the audio device 206 such that the operation of at least one of the first watermarked audio stream and the second watermarked audio stream are controlled based on receiving the user input on the audio device 206.

The method 1200 includes transmitting, by the UE 202, each of the filtered plurality of left watermarked channel signals and the filtered plurality of right watermarked channel signals to the audio device 206. Each signal may be transmitted such that the audio device 206 decodes each of the at least one filtered left watermarked channel signal on the first channel 428 and the at least one filtered right watermarked channel signal on the second channel 430 to control the operation of at least one of the at least one filtered left watermarked channel signal and the at least one filtered right watermarked channel signal based on receiving the user input on the audio device 206.

The method 1200 includes receiving, by the UE 1200, the input associated with the operation of at least one of the at least one filtered left channel signal and the at least one filtered right channel signal. The method 1200 includes correlating, by the UE 202, the received input with a predetermined input signal associated with the operation of at least one of the at least one filtered left channel signal and the at least one filtered right channel signal. The method 1200 includes executing, by the UE 202, the operation, based on the correlation.

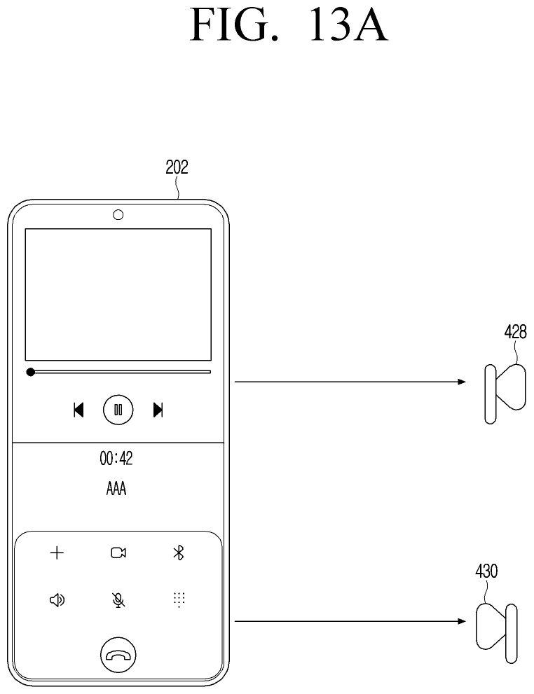

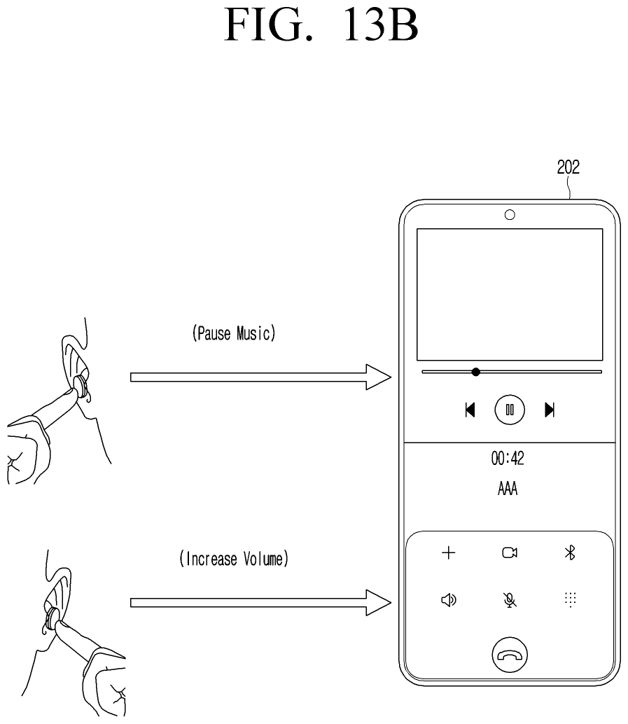

FIGS. 13A and 13 B are diagrams illustrating example use cases of the system 204, according to various embodiments.

Referring to FIG. 13A, if the plurality of audio streams is received on the UE 202 which is intended to be stream on the audio device 206, in that case, the plurality of audio streams may be transmitted on the plurality of channels of the audio device 206. The system 204 and the UE 202 ensure that the user may be able to listen to each audio stream independently and clearly on each channel unlike as known art where the user used to listen to the plurality of audio streams together in the mixed format. The system 204 and the UE 202 may generate stereo mode like sound on both channels. In one example, one application is playing songs and simultaneously, the user is speaking to someone from the UE 202. In that case, the audio stream from the application may reach the first channel 428 of the audio device 206. The voice from the call may reach the second channel 430 of the audio device 206. This ensures that the user may be able to listen to each audio stream independently and clearly on each channel.

Referring to FIG. 13B, if the plurality of audio streams is received on the UE 202 which is intended to be streamed on the audio device 206, in that case, the plurality of audio streams may be transmitted on the plurality of channels of the audio device 206. Further, the system 204 and the UE 202 ensure that the user may control at least one of the plurality of audio streams by providing the input on at least one of the plurality of channels unlike as the known art where if the input from the user may be provided on at least one of the channel, then both audio stream may operate accordingly based on the input.

In an example, if the user taps on the second channel, the music from the application stops. Further, if the user taps the first channel, in that case, the volume of the call is increased unlike the known art, where when the user taps at least one of the first channel and the second channel, in that case, both the music and the call may operate combinedly.

The present system 204, the UE 202, the method 1100, and the method 1200 provide various advantages. The present configuration provides at least the following example advantages:
The system 204, the UE 202, the method 1100, and the method 1200 ensure independent control of at least one of the first audio stream 406 and the second audio stream, 408 in the audio device 202 based on the watermark as encoded with each audio stream.
Further, system 204, the UE 202, the method 1100, and the method 1200 provide stereo sound effects on each of the first channel 428 and the second channel 430 of the audio device 206. This ensures a realistic experience of the first audio stream 406 and the second audio stream 408 on the audio device 206. This configuration enhances user experience and also eliminates the discomfort of the user.

In this application, unless specifically stated otherwise, the use of the singular includes the plural, and the use of “or” may include “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the disclosure to produce various embodiments. Furthermore, certain features may sometimes be used to advantage without a corresponding use of other features.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for controlling at least one of a plurality of audio streams in an audio device, the method comprising:
receiving a first audio stream and a second audio stream from the plurality of audio streams, wherein each of the first audio stream and the second audio stream corresponds to an encoded signal including a watermark;
initiating an operation of the first audio stream and the second audio stream on the audio device; and
controlling the operation of at least one of the first audio stream and the second audio stream based on receiving an input.

2. The method as claimed in claim 1, wherein the first stream and the second stream are received from a user equipment (UE).

3. The method as claimed in claim 1, wherein the operation includes at least one of a play control, a pause control, or a volume control.

4. The method as claimed in claim 1, wherein the operation of each of the first audio stream and the second audio stream is controlled based on the watermark based on Audio Video Remote Control Profile (AVRCP).

5. The method as claimed in claim 1, wherein the watermark includes an audio control information configured to control the operation of at least one of the first audio stream and the second audio stream on the audio device.

6. The method as claimed in claim 1, wherein each of the first audio stream and the second audio stream are controlled independently of each other.

7. A method for controlling at least one of a plurality of audio streams, the method comprising:
receiving, by a user equipment (UE), a first audio stream and a second audio stream from the audio streams intended to be streamed on an audio device;
encoding, by the UE, the first audio stream and the second audio stream, and a watermark corresponding to each of the first audio stream and the second audio stream to generate a mixed encoded signal; and
transmitting, by the UE, each of a first watermarked audio stream and a second watermarked audio stream, from the generated mixed encoded signal, to the audio device such that an operation of at least one of the first watermarked audio stream and the second watermarked audio stream are controlled based on receiving an input on the audio device.

8. The method as claimed in claim 7, wherein the first audio stream and the second audio stream are received from one or more applications installed on the UE.

9. The method as claimed in claim 7, wherein the watermark includes an audio control information to configure the audio device to control each of the first audio stream and the second audio stream independently of each other.

10. The method as claimed in claim 7, wherein the watermark corresponding to each of the first audio stream and the second audio stream is generated using a bit-stream watermark modulation technique.

11. The method as claimed in claim 7, wherein the first audio stream and the second audio stream and the watermark corresponding to each of first audio stream and the second audio stream are encoded using a pulse code modulation technique.

12. The method as claimed in claim 7, wherein, based on encoding the first audio stream and the second audio stream and the watermark corresponding to each of the first audio stream and the second audio stream, the method comprises:
converting, by the UE, the generated mixed encoded signal into stereo signals wherein the stereo signals includes a plurality of left watermarked channel signals corresponding to each of the first audio stream and the second audio stream and a plurality of right watermarked channel signals corresponding to each of the first audio stream and the second audio stream; and
filtering, by the UE, each of the plurality of left watermarked channel signals and the plurality of right watermarked channel signals for deciding that at least one filtered left watermarked channel signal and at least one filtered right watermarked channel signal is to be decoded on a first channel and a second channel of the audio device, respectively.

13. The method as claimed in claim 12, wherein the method comprises:
transmitting, by the UE, each of the filtered plurality of left watermarked channel signals and the filtered plurality of right watermarked channel signals to the audio device such that the audio device decodes each of the at least one filtered left watermarked channel signal on the first channel and the at least one filtered right watermarked channel signal on the second channel to control the operation of at least one of the at least one filtered left watermarked channel signal and the at least one filtered right watermarked channel signal based on receiving the user input on the audio device.

14. The method as claimed in claim 13, wherein the method comprises:
receiving, by the UE, an input associated with the operation of at least one of the at least one filtered left channel signal and the at least one filtered right channel signal;
correlating, by the UE, the received input with a specified input signal associated with the operation of at least one of the at least one filtered left channel signal and the at least one filtered right channel signal; and
executing, by the UE, the operation, based on the correlation.

15. An electronic device configured to control at least one of a plurality of audio streams, comprises:
a memory storing instructions;
at least one processor, comprising processing circuitry;
wherein at least one processor individually or collectively, is configured to execute the instructions and to cause the electronic device to:
receive a first audio stream and a second audio stream from the plurality of audio streams, wherein each of the first audio stream and the second audio stream corresponds to an encoded signal having a watermark;
initiate an operation of the first audio stream and the second audio stream; and
control the operation of at least one of the first audio stream and the second audio stream based on receiving an input.

16. The electronic device as claimed in claim 15, wherein the first stream and the second stream are received from a user equipment (UE).

17. The electronic device as claimed in claim 15, wherein the operation includes at least one of a play control, a pause control, or a volume control.

18. The electronic device as claimed in claim 15, wherein the operation of each of the first audio stream and the second audio stream is controlled based on the watermark based on Audio Video Remote Control Profile (AVRCP).

19. The electronic device as claimed in claim 15, wherein the watermark includes an audio control information configured to control the operation of at least one of the first audio stream and the second audio stream on the audio device.

20. The electronic device as claimed in claim 15, wherein each of the first audio stream and the second audio stream are controlled independently of each other.
